(19) United States
(12) Patent Application Publication
(10) Pub. No.: US 2008/0155293 A1
(43) Pub. Date: Jun. 26, 2008

(54) Apparatus, systems and methods for reliably detecting faults within a power distribution system

(75) Inventors: Veselin Skendzic, Pullman, WA (US); Gregory C. Zweigle, Pullman, WA (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(73) Assignee: Schweitzer Engineering Laboratories, Inc.

(21) Appl. No.: 11/540,254

(22) Filed: Sep. 29, 2006

(51) Int. Cl. G06F 1/00

(52) U.S. Cl. 713/340

(57) ABSTRACT

At least one of input channel containing information relative to a power system or a subpart of a power system is analyzed by a computation engine along with a test data channel. The results of the computation performed on the test data channel are compared against a predetermined test result, and if the two differ, a corrective action is taken.

### CROSS-REFERENCE TO RELATED APPLICATIONS

None

### FIELD OF THE INVENTION

The present invention relates generally to apparatus, systems, and methods for power protection, and more specifically, to apparatus, systems, and methods for validating decision making mechanisms within a power protection system.

### DESCRIPTION OF THE PRIOR ART

Power transmission and distribution networks require an extremely high degree of reliability. Failures in such systems can lead to blackouts. Electrical switchgear, such as circuit breakers and reclosers, are deployed in power networks to isolate faults while maintaining power to as many end users as possible. Usually, a digital intelligent electronic device, such as a protective relay or recloser control, controls the operation of electrical switchgear. However intelligent electronic devices are susceptible to errors caused by background radiation. In particular, memory components used within intelligent electronic devices are susceptible to bit errors caused by high energy particles such as alpha particles or neutrons.

A number of techniques have been disclosed in the prior art detailing methods for reducing errors caused by radiation and other unpredictable sources of errors. For instance, U.S. Pat. No. 6,886,116, issued to Christopher MacLellan, discloses a system for validating error detection logic in a data storage system. MacLellan utilizes a plurality of fault injectors to create erroneous conditions, and then utilizes additional logic to ensure that the error detection logic picks up on the error and does not interfere with the normal operation of the device. MacLellan is a good example of an error detection technique applied to a combined hardware/software system.

U.S. Pat. No. 6,594,774, issued to Craig Chapman and Mark Moeller, focuses exclusively on software errors. In addition to other techniques, Chapman applies the concept of a watchdog timer to individual software processes. A watchdog timer is a hardware timer coupled to a microprocessor that must be reset within a given time period or the watchdog timer causes the microprocessor to reset. In Chapman, individual executable fibers (i.e.; threads or processes) register with a watchdog thread. The executable fibers must then notify the watchdog thread periodically, or the watchdog thread takes a containment action, such as terminating the thread.

Many techniques suited to other industries are not necessarily well suited to the power protection industry. Power protection devices often operate in hostile environments, with large amounts of electromagnetic radiation present. Historically, the power protection industry has dealt with this problem through the use of shielding, grounding, and other basic mechanical and electrical techniques, as well as readback validation of memory structures. Given the sensitivity of the power grid to failures, there is a continuing need within the power protection industry to devise techniques to further reduce the failures of power protection devices and thereby improve the reliability of the power grid.

### OBJECTS OF THE INVENTION

Accordingly, it is an object of this invention to provide reliable power system automation and control capable of detecting and correcting a large percentage of would-be failures, and thereby raising the overall reliability of the power grid.

Another object of this invention is to provide a system for reliably identifying and isolating faults in a monitored power line with fault detection logic that can, in a large percentage of cases, detect when it has erroneously detected a fault, and prevent the system from taking adverse action based on the erroneously detected fault.

### SUMMARY OF THE INVENTION

The disclosed invention achieves its objectives through the use of a test data channel that is processed by the same hardware and software that monitors actual data channels. A plurality of input channels containing digital information regarding the power system or a subpart of the power system is analyzed by a computation engine concurrently with a test data channel in a time interleaved manner using the same execution path on the different channels on a sample by sample basis, where an execution path consists of hardware, firmware and software used to implement the utilized algorithm. The test data channel is preferably designed to fully exercise the executable code of the computation engine. The results of the computation performed on the test data channel is compared against a predetermined test result, and if the two differ, a corrective action is taken. Corrective actions range from shutting the system down, to discarding all results from the sampling period when the erroneous reading occurred, to logging the erroneous computation.

The disclosed invention may also be implemented as a method for reliable power system automation or control. A plurality of digital input channels is monitored along with a test data channel. A computation engine performs analysis on all of the channels using a power system analysis algorithm, and produces a plurality of decision data channels and a test result data channel. The test result data channel is compared against a predetermined test result and a corrective action is initiated if the two differ.

### BRIEF DESCRIPTION OF THE DRAWINGS

Although the characteristic features of this invention will be particularly pointed out in the claims, the invention itself, and the manner in which it can be made and used, can be better understood by referring to the following description taken in connection with the accompanying drawings forming a part hereof, wherein like reference numerals refer to like parts throughout the several views and in which:

FIG. 1 is a simplified functional block diagram of a power automation or control system utilizing a known test channel to test the operation of computational components.

FIG. 2 is a simplified functional block diagram of an intelligent electronic device executing a reliable fault detection algorithm.

FIG. 3 is a simplified functional block diagram illustrating a separate embodiment of an intelligent electronic device executing a fault detection algorithm.

### DETAILED DESCRIPTION OF THE ILLUSTRATED EMBODIMENTS

Many power control and automation systems process time interleaved channels of data. For instance, a single processor often analyzes three separate phases of current and voltage. An embodiment of the disclosed invention improves the reliability of such a system through the use of additional channels of known test data. The channels of known test data are processed by the same computation engine that processes current and/or voltage data, and a test result channel is produced. The test result channel is then compared against a predetermined test result, and if the test result channel does not match the predetermined test result, an error is noted, and a corrective action is taken.

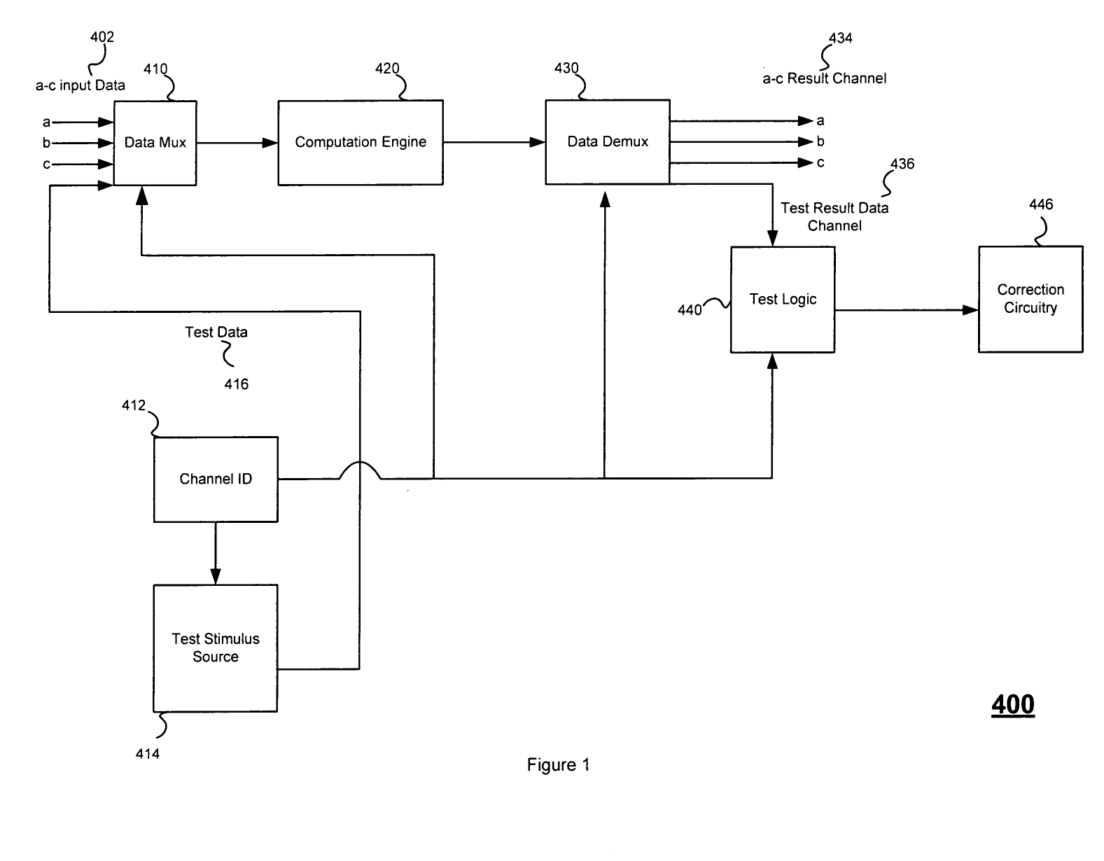

Referring to the Figures, and in particular to FIG. 1, a power monitoring and control system 400 utilizing the disclosed invention is illustrated. Input channels of data 402a-c are multiplexed and interleaved by a data multiplexer 410. In this case the number of input channels is shown as three but any number of channels, from a single channel to many more channels, can operate similarly. An additional channel of test data 416 is provide by a test stimulus source 414. A computation engine 420 applies a power system analysis algorithm to all channels of input data including the input data channels 402a-c and the test data channel 416. The computation engine 420 then generates a number of result channels 434a-c and a test result data channel 436. Alternatively, the computation engine 420 could output data through a data demultiplexer 430 which produces result channels 434a-c and a test result data channel 436 with the assistance of a channel ID register 412, which keeps track of the channel that the computation engine 420 last worked on. The test result data channel 436 is compared against a predetermined test result by test logic 440, and if the test result data channel 436 differs from the predetermined test result, an error is noted, and the correction circuitry 446 is activated to initiate corrective action. Corrective actions can include, for instance, resetting the computation engine 420, causing an operator to be notified, refreshing corrupted memory within the computation engine 420, stopping all processing within the computation engine for a period of time, or discarding all calculations performed by the computation engine within a specific period of time, such as that defined by a system sampling period (the period of time required to perform calculations on all data channels and the test data channel). The specified period of time can be applied only backwards in time or both backwards and forwards in time.

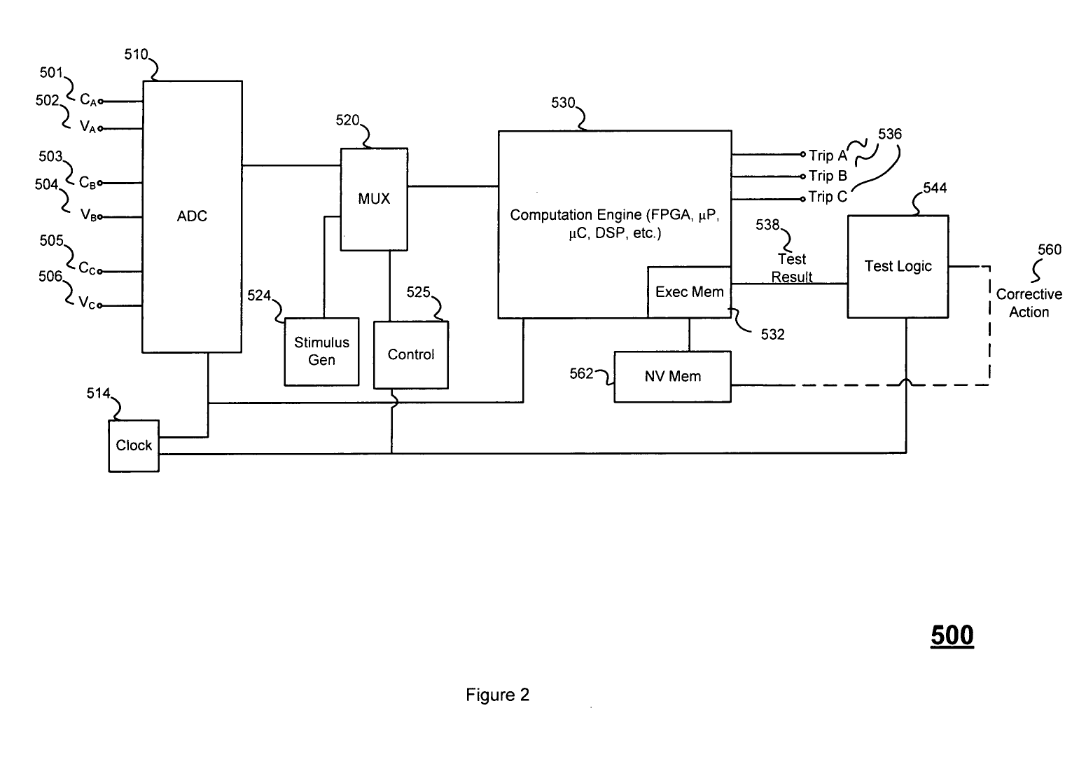

FIG. 2 depicts the major functional and control blocks of an electronic monitoring system 500 utilizing an additional time interleaved test data channel to reliably detect a fault on a monitored power conductor. Three phases of current and voltage are acquired in channels 501-506 and converted into digital form by analog to digital converter 510. Note that acquisition of both voltage and current are not required for a robust fault detector, and are only shown here as one possible implementation of the disclosed invention. Analog to digital converter 510 samples different channels at a rate determined by clock 514. The clock 514 is representative of a synchronizing mechanism and can be implemented using one of multiple approaches, for example a crystal, or a control mechanism implemented within the computation engine 530. Sampled data is passed through a multiplexer 520 along with one channel of test data generated by a stimulus source 524. An additional control line 525 determines whether one of the digital phase parameters is passed by the multiplexer 520 or whether the test stimulus is passed. The computation engine 530 performs a fault detection algorithm on the tested data, where the particular fault detection algorithm may be any appropriate algorithm selected from the prior art. The multiplexer 520, stimulus source 524, or control 525 can be implemented external to computation engine 530, as shown in FIG. 2, or internal to the computation engine. In this sense these operations can be implemented either using hardware or software.

The computation engine 530 contains executable memory 532, which is susceptible to corruption from external sources such as radiation. Additionally, the computation engine 530, along with any of the clock 514, stimulation source 524, control 525, mux 520, and test logic 544 can be susceptible to corruption from external sources such as radiation. The executable memory 532 is loaded from non-volatile memory 562. Note that many other configurations of memory can utilize the principles of this invention. For instance, the computation engine 530 could execute directly from the non-volatile memory 562, or the non-volatile memory 562 or execution memory 532 and the computation 530 could both be implemented within an FPGA. In this case the execution memory 532 is representative of the configuration memory internal to the FPGA. In some cases the non-volatile memory 562 is not included with the system or represents a mass storage magnetic media.

The computation engine produces trip outputs 536A-C and test result 538 by using the same fault detection algorithm on the different channels of data it receives from multiplexer 520. The test result 538 is then examined by test logic 544, which compares the test result 538 against a predetermined test result. If the test result 538 does not match the predetermined test result a corrective action 560 is output. As depicted, the corrective action 560 is for the non-volatile memory 562 to refresh the executable memory 532 of the computation engine. A number of different techniques may be applied when refreshing the executable memory; among them, the entire executable memory 532 may be refreshed (effectively resetting the computation engine 530), a predetermined section or sections may be refreshed, or sections identified as corrupted may be refreshed. Other potential corrective actions as identified earlier may be taken as well.

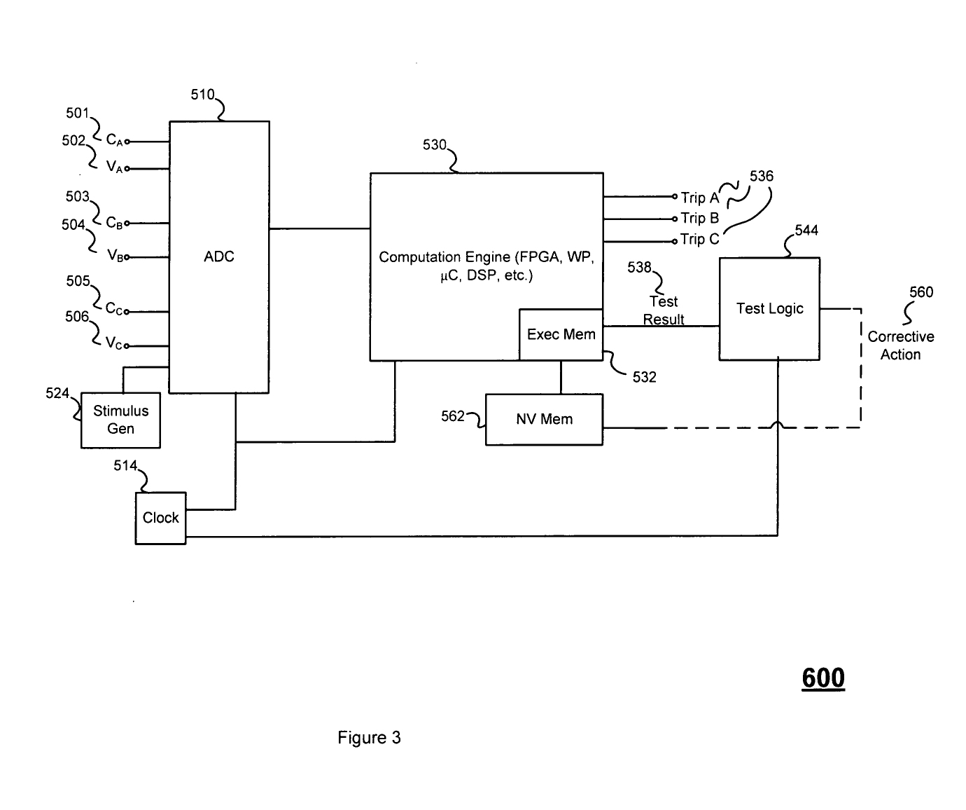

FIG. 3 shows an electronic monitoring and control system 600 substantially identical to the device shown in FIG. 2, except that the test stimulus source 524 has been modified to produce an analog test signal, and accordingly, has been moved to feed into the analog to digital converter 510. In addition, as the multiplexer 520 and control block 525 of FIG. 2 are no longer required, they have been removed. The embodiment of FIG. 3 has the additional benefit of exercising the analog to digital converter 510 as well as the remainder of the hardware.

Note that the invention described herein utilizes a digital processor. As the algorithms described do not require any particular processing characteristics, any type of processor will suffice. For instance, microprocessors, microcontrollers, digital signal processors, field programmable gate arrays, application specific integrated circuits (ASIC) and other devices capable of digital computations are acceptable where the terms processor or computation engine are used.

The foregoing description of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

I claim:

1. A system for reliable detection and correction of computation errors comprising:
i) at least one input data channel;
ii) a test data channel having a known stimulus;
iii) a computation engine coupled to said input data channel and said test data channel and performing data analysis on said input data channel and said test data channel in an operating cycle and producing at least one decision data channel and a test result data channel;
iv) a test logic block coupled to the computation engine and operating on said test result data channel and comparing the test result data channel to a predetermined test result and producing a corrective action if the test result data channel differs from the predetermined test result.

2. The system of claim 1, wherein a detection and correction method is used to improve power system automation or control.

3. The system of claim 1, wherein said input data channel monitors a voltage and a current, said voltage and current being derived from a power conductor.

4. The system of claim 1, wherein said input data channel monitors a voltage associated with a power conductor.

5. The system of claim 1, wherein said input data channel monitors a current associated with a power conductor.

6. The system of claim 1, wherein said computation engine performs a fault detection algorithm.

7. The system of claim 1, further comprising a test stimulus source coupled to said test data channel and to said test logic block for generating a plurality of known stimuli and wherein said test logic block comprises a plurality of predetermined test results corresponding to said plurality of known stimuli.

8. The system of claim 1, wherein said computation engine performs identical computations on the at least one input data channel and said test result data channel.

9. The system of claim 1, wherein said corrective action comprises notifying an operator of the occurrence of the error.

10. The system of claim 1, wherein said corrective action comprises invalidating all decision data channel data produced within a specified period of time.

11. The system of claim 1, further comprising a non-volatile memory and wherein the computation engine further comprises an executable memory and said corrective action is refreshing said executable memory from said non-volatile memory.

12. The system of claim 10, wherein said executable memory is the non-volatile memory.

13. A monitoring and control device for monitoring a power conductor in a power system comprising:
i) at least one current acquisition sensor electrically coupled to the power conductor for sensing the current therein;
ii) an analog to digital converter coupled to said current acquisition sensor for producing at least one digital current;
iii) a test stimulus source for generating a test stimulus;
iv) a computation engine coupled to said analog to digital converter and said test stimulus source for producing a trip output in response to the current in said power conductor and also producing a test result corresponding to said test stimulus; and
v) test logic coupled to said computation engine for receiving the test result and comparing said test result with a predetermined test result corresponding to the test stimulus and producing a corrective action when the test result is different from the predetermined test result.

14. The monitoring and control device of claim 12, wherein said test stimulus source generates a plurality of stimuli and said test logic comprises a plurality of predetermined test results corresponding to said plurality of stimuli.

15. The monitoring and control device of claim 12, further comprising a non-volatile memory and wherein said computation engine has an executable memory and said corrective action is refreshing said executable memory from said non-volatile memory.

16. A monitoring and control device for monitoring a power conductor in a power system comprising:
i) at least one voltage acquisition sensor electrically coupled to the power conductor for sensing the voltage applied thereto;
ii) an analog to digital converter coupled to said voltage acquisition sensor for producing at least one digital voltage;
iii) a test stimulus source for generating a test stimulus;
iv) a computation engine coupled to said analog to digital converter and to said test stimulus source for producing a trip output responsive to the current level of the power conductor and also for producing a test result corresponding to said test stimulus; and
v) test logic coupled to said computation engine for receiving said test result and comparing said test result to a predetermined test result corresponding to said test stimulus and for producing a corrective action when said test result is different from said predetermined test result.

17. A monitoring and control device for monitoring a power conductor in a power system comprising:
i) at least one current acquisition sensor electrically coupled to the power conductor for sensing the current therein;
ii) at least one voltage acquisition sensor electrically coupled to the power conductor for sensing the voltage applied thereto;
iii) a test stimulus source for generating an analog test stimulus;
iv) an analog to digital converter coupled to said current acquisition sensor and said voltage acquisition sensor for producing at least one digital current output and at least one digital voltage output and further coupled to said test stimulus source for producing a digital test stimulus output;
v) a computation engine coupled to said analog to digital converter for applying a fault detection algorithm to said digital current output, said digital voltage output, and the digital test stimulus output, and for producing a trip output responsive to the current and the voltage on said power conductor and also producing a test result corresponding to said digital test stimulus; and
vi) test logic coupled to said computation engine for receiving said test result and comparing said test result to a predetermined test result corresponding to said test stimulus for producing a corrective action when said test result is different from said predetermined test result.

18. The monitoring and control device of claim 16, wherein said test stimulus source generates a plurality of stimuli and said test logic comprises a plurality of predetermined test results corresponding to said plurality of stimuli.

19. The monitoring and control device of claim 16, further comprising a non-volatile memory and wherein said computation engine has an executable memory and said corrective action is refreshing said executable memory from said non-volatile memory.

20. A method for reliable power system automation or control comprising the steps of:
i) monitoring at least one input data channel;
ii) monitoring a test data channel;
iii) analyzing the at least one input data channel and the test data channel using a power system analysis algorithm;
iv) producing at least one decision data channel and a test result data channel;
v) comparing the test result data channel to a predetermined test result; and
vi) initiating a corrective action if the test result data channel differs from the predetermined test result.

21. The method of claim 19, further comprising the step of generating a test stimulus corresponding to a specific test result of a plurality of predetermined test results and initiating a corrective action if the test result data channel differs from the specific test result.

22. The method of claim 19, wherein the step of analyzing is fulfilled through a fault detection analysis.

23. The method of claim 19, wherein the step of initiating is fulfilled by notifying an operator of the occurrence of the error.

24. The method of claim 19, wherein the step of initiating is fulfilled by invalidating all decision data channels produced within a specified time period of the production of the test result data channel.
